(19) United States
(12) Patent Application Publication
(10) Pub. No.: US 2026/0057419 A1
(43) Pub. Date: Feb. 26, 2026

(54) User Interaction with Video Feeds and Other Media Feeds with Ad Insertion Based on User Interaction

(71) Applicant: Unity Technologies SF, San Francisco, CA (US)

(72) Inventors: Mikko Repo, Tampere (FI); Samuli Hynönen, Espoo (FI); Matti-Pekka Ritvola, Montreal (CA); Tuomas Harju, Kirkkonummi (FI); Ziwen Li, Vancouver (CA); Antti Moilanen, Espoo (FI); Valentin Kononov, Espoo (FI); Heikki Laitala, Helsinki (FI); Felix The, San Francisco, CA (US)

(21) Appl. No.: 18/811,573

(22) Filed: Aug. 21, 2024

(51) Int. Cl. G06Q 30/0241; G06Q 30/0273

(52) U.S. Cl. CPC G06Q 30/0277; G06Q 30/0275

(57) ABSTRACT

Content comprising a content portion and an advertisement portion is presented to a user via a client device, by requesting presentation content from a content server, presenting, using the client device, a presentation derived from the presentation content, determining when a presentation reaches an advertisement insertion point in the presentation, prior to reaching the advertisement insertion, requesting an ad collection, the ad collection comprising a plurality of ad impressions, for an advertisement presentation for the advertisement insertion point, presenting the user with a first ad impression of the ad collection, receiving user interactions of the user with the first ad impression, recording the user interactions as stored actions data, and taking an action in response to the user interactions, wherein the action for at least one specific user interaction is to change from presenting the first ad impression to presenting a second ad impression of the ad collection.

### FIELD

The present disclosure generally relates to computer systems where content is served to client devices and more particularly to content delivery systems that incorporate advertising content into media feeds such as video feeds.

### BACKGROUND

Content delivery systems and infrastructure have been used to deliver content from servers to clients. The content might be multimedia presentations and might be software, such as video game content, that a user of a client device can interact with. For example, a user using a client device might access a game server to download a computer game to play on their client device. The client device might be a desktop computer, laptop computer, tablet computer, mobile smartphone, etc. The content would then execute on the client device and might, in part, execute remotely as needed by the client device.

The content delivery infrastructure might be set up with games being delivered to client devices with advertising content so that the games, and other content, might be ad-supported in whole or in part. A game server might, for example, serve ad-supported games to players who are using client devices and as a game is played, the game would make calls to an advertisement server from time to time to retrieve content for an advertisement. Various player client devices, such as a desktop computer or mobile device, running client software, such as an interactive game, would receive game content including the advertisements embedded in the game content or served separately.

Delivery and tracking of ad impressions in content delivery environments can be improved.

### SUMMARY

In some embodiments, content is presented to a user via a client device, wherein the content comprises a content portion and an advertisement portion, with a method comprising requesting, from the client device, presentation content from a content server, presenting, using the client device, a presentation derived from the presentation content, determining when a presentation reaches an advertisement insertion point in the presentation, prior to reaching the advertisement insertion, requesting an ad collection, the ad collection comprising a plurality of ad impressions, for an advertisement presentation for the advertisement insertion point, presenting the user with a first ad impression of the ad collection, receiving user interactions of the user with the first ad impression, recording at least indicia of the user interactions as stored actions data, and taking an action in response to the user interactions, wherein the action for at least one specific user interaction is to change from presenting the first ad impression to presenting a second ad impression of the ad collection.

The presentation content might comprise an interactive video game. The user interaction might comprise a swiping motion of the user on a display screen of the client device. The action in response to the user interaction might be selected from among (a) playing a current ad presentation, (b) skipping the current ad presentation, (c) moving to a next ad presentation of the ad collection, and/or (d) returning to a prior ad presentation of the ad collection, with a selection being determined based on a type of the swiping motion of the user.

The plurality of ad impressions of the ad collection might be limited to ad impressions of one advertiser comprise ad impressions of more than one advertiser. The ad collection might include an indication of ordering among the plurality of ad impressions of the ad collection, including a first ad impression and a last ad impression. Thus, as an ad collection is requested by a client device and sent to the client device, it might include an indication of a presentation order among the plurality of ad impressions of the ad collection. The ordering among the plurality of ad impressions of the ad collection might be determined by an auction process and bids placed by advertisers of the more than one advertiser. It might be that the first ad impression for an ad presentation is for the winning bidder in an ad auction.

The ad collection might be requested by sending an ad collection request from the client device to the content server to be forwarded to an ad server, or by sending an ad collection request from the client device to an ad server that is distinct from the content server.

The advertisement insertion point might represent a point in a game suitable for a break in game play action, a first predetermined time since a game start time, a second predetermined time since a prior advertisement insertion point, and/or a combination thereof. An ad session might begin at the advertisement insertion point and have an ad session period after which the presentation content resumes. The ad session period might be a fixed, predetermined period of time, lasts until an ad session ending user action is detected, and/or until the user is presented with the last ad impression. In some cases, there might not be an ad impression that is specifically designated as the last ad impression, in which case the last ad seen by the user might just happen to be the last ad impression because some other operation resulted in the ad session period ending.

In some cases, the advertisement insertion point might be user-initiated, such as where the game provides rewards for ad viewing and the user during game play decides to trigger such a reward operation. For example, a game might include a menu option or button for a user to get a reward in exchange for viewing ad impressions. The reward might be some in-game asset, such as gold coins, gems, a power-up, added health, restoring a life after an in-game death, or some other benefit the user might be interested in and can choose to initiate a user-initiated ad session.

Processing of the stored actions data of the user with other stored actions data of other users might be performed by a machine learning system trained on the stored actions data of a plurality of users.

A computer-readable medium might be deployed that carries instructions that, when executed by at least one processor of a computer system, causes the computer system to carry out one or more of the methods described herein.

A client device might comprise storage for presentation content received from a content server, a user interface for presenting content and receiving user input, a network interface usable for communication with remote devices, and a processor for executing program instructions stored on the client device, the program instructions including instructions to: (a) present a presentation derived from the presentation content, (b) determine when a presentation reaches an advertisement insertion point in the presentation, (c) request an ad collection comprising a plurality of ad impressions, (d) present the user with a first ad impression of the ad collection in an advertisement presentation for the advertisement insertion point, (e) record at least indicia of user interactions of the user interacting with the first ad impression, recorded as stored actions data, and (f) taking an action in response to the user interactions, wherein the action for at least one specific user interaction is to change from presenting the first ad impression to presenting a second ad impression of the ad collection.

The presentation content might comprise an interactive video game and the user interaction is a swiping motion of the user on a display screen of the client device, and wherein the action in response to the user interaction might be selected from playing a current ad presentation, skipping the current ad presentation, moving to a next ad presentation of the ad collection, or returning to a prior ad presentation of the ad collection, with a selection being determined based on a type of the swiping motion of the user.

The client device might perform one or more of the methods described herein.

An ad session might begin at the advertisement insertion point and has an ad session period after which the presentation content resumes, wherein the ad session period is a fixed, predetermined period of time, and/or wherein the ad session period lasts until an ad session ending user action is detected.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a diagram of infrastructure that can be used for a content presentation platform, according to various embodiments.

FIG. 2 is a detailed diagram illustrating aspects of interactions between an ad server and a client device, such as those shown in FIG. 1, for sending ad session requests and receiving ad session responses.

FIG. 3 is a block diagram illustrating interactions between a client device and a user interaction analyzer, according to various embodiments.

FIG. 4 illustrates a content presentation timeline and the components thereof, according to various embodiments.

FIG. 5 is a view of a client device presenting content thereon, according to various embodiments.

FIG. 6 is a view of a client device presenting content thereon with an overlaid advertisement session, according to various embodiments.

FIG. 7 is a block diagram of various components and their connections, according to various embodiments.

FIG. 8 illustrates an example computer system memory structure as might be used in performing methods described herein, according to various embodiments.

FIG. 9 is a block diagram illustrating an example computer system upon which the systems illustrated in FIGS. 1 and 8 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

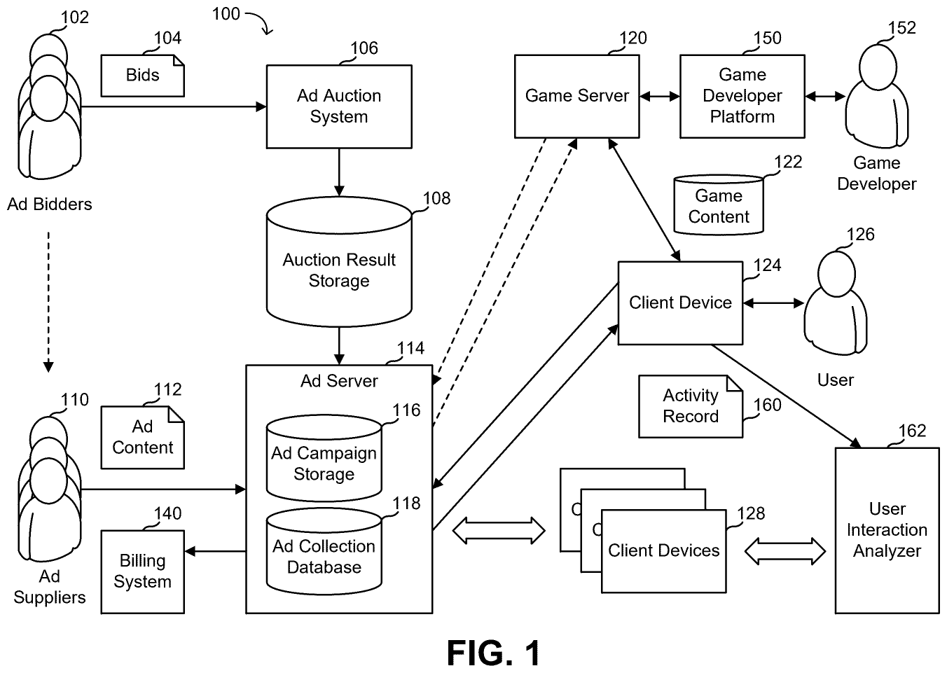

FIG. 1 is a diagram of infrastructure 100 that can be used for a content presentation platform, according to various embodiments. Using infrastructure 100, a game server or other server might provide content to users using a client device in the form of a user presentation that is served to a client device being used by a user. A specific instance of a user presentation might be a video game and the user might be player of that video game, but other media types and other user presentations are possible. Infrastructure 100 might be designed as a content provision system or might be a more general infrastructure. A content provision system might be system that provides streaming video games to client devices and includes advertising content that is presented on the client devices to users to provide ad-supported content, comprising an advertising auction system that advertisers interact with and that determines which advertisements will be serve, an advertisement server that serves ad collections in response to ad session request from a game server or a client device, where an ad collection might comprise a plurality of ad impressions collected as a unit. The content provision system might also comprise a game server that serves games to client devices, a network that connects the various components, allowing them to be distributed, instances of client devices such desktop computers and mobile devices, and an interaction analysis system that collects data about how users of client devices interact with ad collections.

As shown in FIG. 1, ad bidders place bids and those bids 104 might be processed by an ad auction system 106. At the conclusion of an auction, auction system 106 might output and store auction results in auction results storage 108. For example, multiple ad bidders 102 might submit bids for a particular set of ad sessions with an auction result being awarded to the highest bidder. Ad suppliers 110 might provide ad content 112 to ad server 114, which can then store ad content 112 into ad campaign storage 116. The ad content might be a video presentation, images—interstitial or otherwise, other media type content, or other content that might be created by advertisers of interest. The ad content might be organized into ad spots and/or be part of an ad campaign.

In some variations, some or all of the functionality of ad campaign storage 116 might be implemented via a content delivery network (CDN). For example, some ad content might be managed by ad server 114 and/or ad campaign storage 116 but the actual content is stored, perhaps for ease of delivery, at a CDN edge device.

It may be that ad bidders 102 and ads suppliers 110 overlap, but that might not be required. In FIG. 1, while ad bidders 102 and ad suppliers 110 are shown as being persons, they might also be implemented as computer systems and possibly fully-automated computer systems. A mediation system might be provided that would allow ad auction system 106, or some other component handing part of the ad auction process, to mediate among an ad inventory to optimize for some parameters. Those parameters might relate to some cost function among the available ads, providing priority to advertisers based on ad payment rates.

As explained herein, ad server 114 might include logic to create ad collections and store them in ad collection database 118, wherein an ad collection comprises a plurality of ad campaigns. An ad collection might be represented in memory as a set of pointers to ad campaigns, and the pointers need not be unique. In some instances, an ad campaign is represented by computer-readable content that can be presented to a user as an ad impression presented to the user in a particular ad placement, such as interspersed with other media content. An ad collection might be a set of ad campaigns that will be available during an ad session that the user can swipe through.

A game server 120 might provide game content 122 to a client device 124 for interaction with a user 126. Game server 120 might be a system that provides game content to multiple client devices such that the users of those devices, who might be referred to as players herein, can interact with the game content as it is presented and/or executed on the client device. As user 126 interacts with client device 124 at various points during a game, an ad session might occur. During that ad session, client device 124 might make an ad session request of ad server 114. An ad session might be a portion of a user presentation allocated to presenting an advertisement to the user. The advertisement can be overlaid on a main user presentation or presented during a break in the main user presentation. An ad request might be a request made by a client device while running the main user presentation to obtain content for an advertisement to be presented to the user running the main user presentation, or the request can be made by a game server that is providing the main user presentation to the client device to. In some implementations, client device 124 will request or obtain an ad collection and/or individual ad campaigns in advance of an ad session.

During an ad session, an ad impression occurs, wherein an impression or placement might be an instance of an advertisement represented by an ad campaign. In a specific example, each ad campaign comprises a video presentation stored by an ad server (and/or a CDN) and an ad impression comprises the presentation and playing of that video presentation on a client device. Where the ad campaign is provided to many client devices, that ad campaign might result in many ad impressions. An ad collection might be representative of a plurality of ad campaigns and thus a plurality of ad impressions on a client device. An ad collection might have an ordering of the ad impression of the ad collection, e.g., there is a first ad impression, a second ad impression, etc. In some embodiments, the ad campaign might comprise an image, audio, or some other form of presentation.

In response to an ad session request, ad server 114 will respond with an ad session response including an ad sent an ad collections object. It some embodiments, the ad session requests come from a game server 120 and the ad session responses are provided to game server 120, which can then integrate the ad campaigns into the game content provided to client device 124.

It should be understood that infrastructure 100 can accommodate many client devices, including client devices 128 that are similarly situated as client device 124 or are different. Further, it should be understood that the user presentations need not be limited to games, in which case game server 120 and game content 122 might be more generally user presentation servers and user content.

In the illustration of FIG. 1, game server 120 interacts with a game developer platform 150, which in turn interacts with a game developer 152, but other methods of generating ad-supported games and user presentations might be implemented instead of or as well. As explained herein, user 126 might interact with user presentations including ad sessions and during those user presentations, client device 124 might make a record of such interactions and provide that as an activity record 160 to a user interaction analyzer 162. User interaction analyzer 162 might be used for refining ad sessions or and/or providing feedback to advertisers and game developers, as well as operators of ad auction system 106 and ad server 114. Also illustrated in FIG. 1 is a billing system 140, which might keep track of ad impressions, ad bids, and the like for charging to advertisers, and might keep track of ad impressions and the user content in which the ad impressions were interposed, as might be used for compensating game developers.

In an operation, for example, a game server might stream game content to a client device and from time to time, such as every 10 minutes or at a predetermined place in the game play (or upon user request), would intersperse the game content with an ad session. In the ad session, ad campaigns obtained from an ad server might be presented. It some variations, the client device can make the call directly to the ad server and in others the request is via the game server.

Some ad-supported game infrastructures might track which ads are shown to which client devices, as well as “click-through” rates reflecting the case when a user clicks on an ad to learn more about the advertised product or service or take some other action of interest to the advertiser, such as buying the product or downloading of the app being advertised. A mobile measurement partner device is a particular class of system that might monitor ad impressions and might include an interaction analysis system. The click-through rates, and maybe even the individual user responses to individual advertisement presentations, might be recorded and that information provided in detail or summary form to the advertiser. In some cases, the billings to the advertiser might be based on that data. For example, an advertiser might be charged a fixed fee for each ad that is presented and a larger fixed fee for each instance where a user took an action specified by the advertisement, such as clicking on the advertiser's link or taken some other action.

In a conventional advertising auction system, advertisers might interact with the auction system by specifying keywords, demographics, and other campaign parameters that form a bid. The bid might define an advertiser's target audience. An advertiser would then interact with the advertising auction system to place bids and compete with other advertisers for placements that meet the campaign parameters. A content server, or an ad server, then serves up the ads of the winning bidders such that the ad might be shown interspersed with content that the content server serves to users of client devices. The ads might be served to users in the target audience.

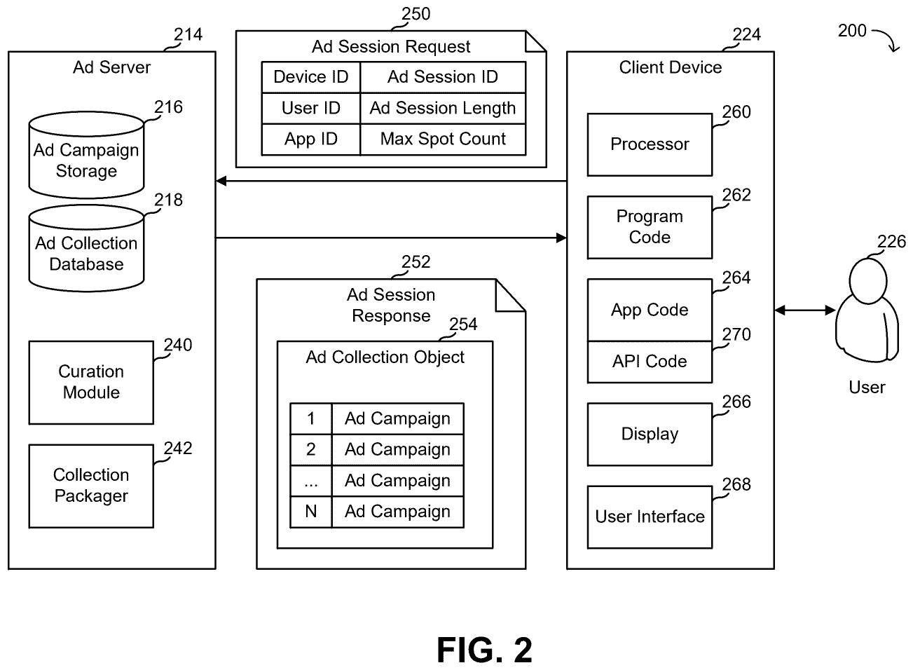

FIG. 2 is a detailed diagram of a system 200 illustrating aspects of interactions between an ad server 214 and a client device 224, in which client device 224 can send ad session requests 250 to ad server 214 and receive ad session responses 252 from ad server 214. Ad server 214 might include an ad campaigns storage 216, and an ad collection database 218, a curation module 240 and a collection generator 242. Curation module 220 might be used to select among ad campaigns in ad campaigns storage 216 to decide which ad campaigns to include in an ad collection, how to order them, and other details as might be applied. Collection generator 242 can then assemble the components of ad collection objects to be provided to client devices and/or game servers.

Client device 224 might comprise a processor 260, program code 262 that can be executed by processor 260, game code 264 that might be downloaded from a game server and can be executed by processor 260, a display 266 for making presentations to a user 226 and a user interface 268 for interacting with user 226. In some embodiments, a game is downloaded onto a client device with some game content is only later streamed from a game server or content delivery network (CDN) to the game on the client device as the user is playing the game.

Game code 264 might have instructions to interact with an application programming interface (API) 270 that might provide the functionality for making ad requests and processing ad session responses. In a specific example, client device 224 sends ad session request 250 to ad server 214 and receives ad session response 252. Among other possible elements of ad session response 252 is an ad collection object 254. Ad collection object 254 might include a plurality of ad campaigns with orderings therein and possibly other information. For example, each ad campaign record in an ad collection object might have some minimum viewing requirement, such as that the user cannot skip past the first ten seconds of the advertisement.

API 270 and/or game code 264 and /r program code 262 might have a client-side ad handling module, wherein the client-side ad handling module can receive a collection of ad impressions and present ad impressions from the collection to the user while receiving user interaction with the collection and changing ad impressions from among the collection in response to the user interaction. The user interaction might be a game, but non-game interactions are also possible. An ad session period might be predetermined or computed, such as starting at a particular time in the presentation and run for a fixed period of time, until some user action, and/or until each ad campaign in the ad collection is placed.

A machine learning system might learn from the user interactions and provide that information to developers and advertisers.

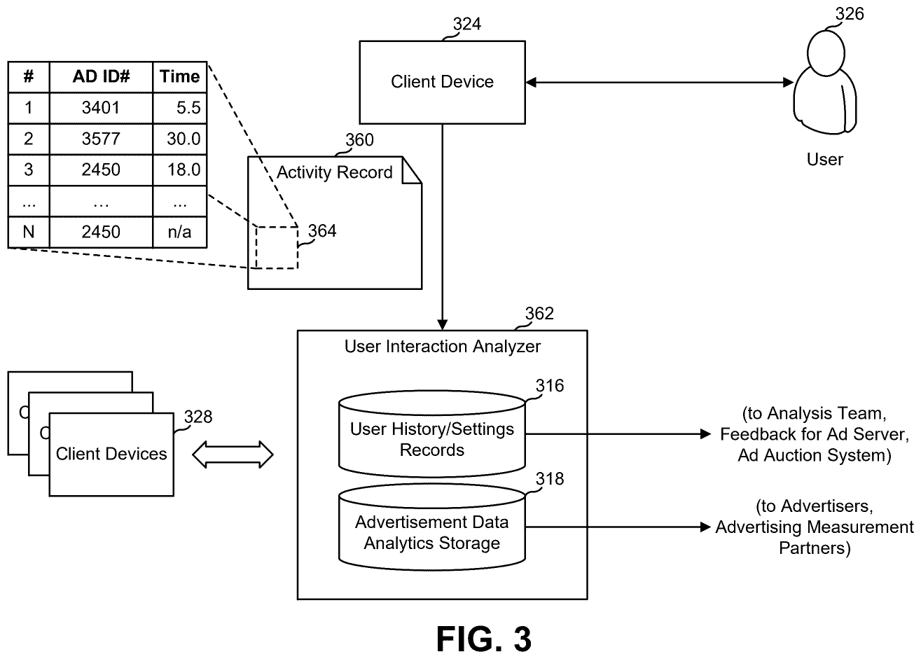

FIG. 3 is a block diagram illustrating interactions between a client device 324 and a user interaction analyzer 362, according to various embodiments. As shown there, as a user 326 interacts with client device 324 during an ad session, client device 324 generates an activity record 360, which might contain details of which ad campaigns were presented as ad impressions, their order of presentation, and the amount of time that the user spent interacting with the ad impression. Activity record 360 can then be provided to user interaction analyzer 362. Additional activity records might be sent to user interaction analyzer 362 by other client devices 328. In the example shown in FIG. 3, the time spent on each ad impression is shown in seconds.

User interaction analyzer 362 might have storage for user history/settings records 316 as might be provided to an analysis team, feedback to an ad server, feedback to an ad auction system, etc., and user interaction analyzer 362 might also include advertisements data analytics storage 318 containing information that can be provided to advertisers, advertisement advertising measurement partners, etc.

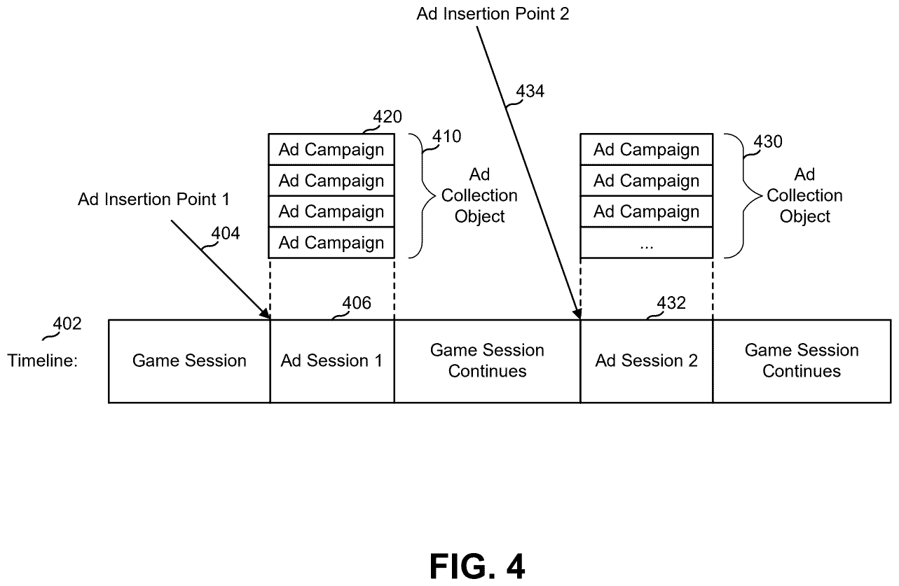

FIG. 4 illustrates a content presentation timeline and the components thereof, according to various embodiments. As shown there, a timeline 402 of user interaction might comprise a game session and, at an ad insertion point 404, an ad session 406. At the conclusion of ad session 406, the game session might continue. Ad insertion point 404 might be determined by the game play, such as occurring upon the completion of one level of a game before proceeding to the next level of the game, at some other suitable break in the game action, or in response to a user request such as where the user knows an ad break could result in a reward and the user is at a point in the game action where the reward would be particularly useful to the user. During ad session 406, a client device might present ad campaigns 420 that are part of an ad collection object 410. The length of ad session 406 might be fixed and the user might dwell on some ad campaigns and thus it is possible that during one ad session not all ad campaigns in an ad collection object would be presented.

In some ad sessions, an ad collection object 430 might refer to an unbounded or indeterminate number of ad campaigns and the number of ad campaigns that are used from ad collection object 430 during a second ad session 432 at a second ad insertion point 434 might be determined at runtime.

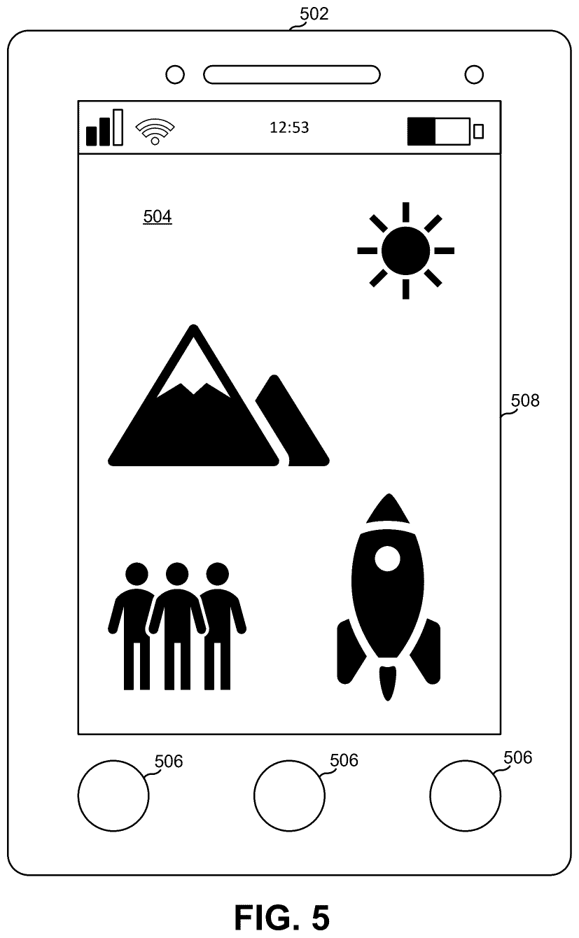

FIG. 5 is a view of a client device 502 presenting content thereon, according to various embodiments. As illustrated there, client device 502 has a display 504 that is presenting to the user an interactive game referred to herein as “Space Adventures Game”. The game might accept user input via buttons 506 and/or touch screen 508.

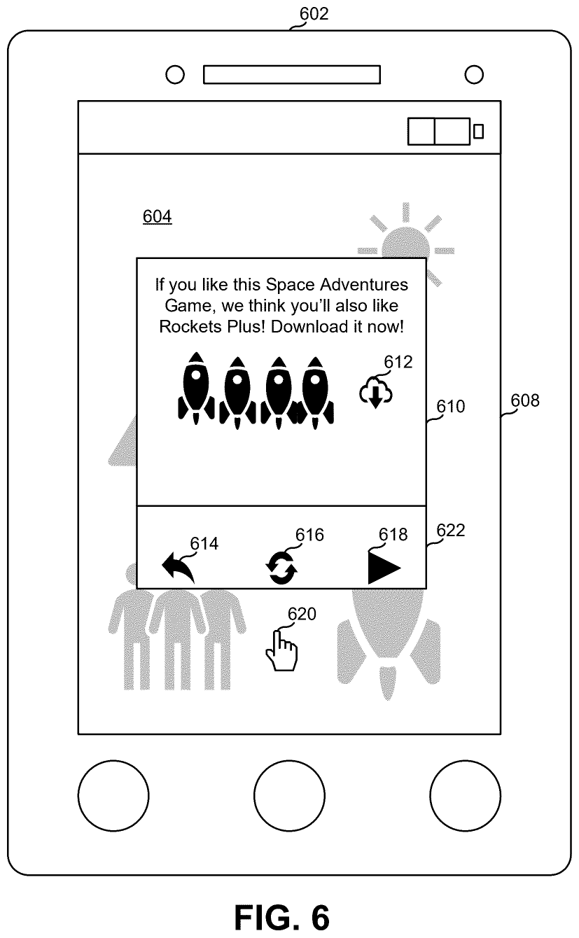

FIG. 6 is a view of a client device 602 presenting content thereon with an overlaid advertisement session, according to various embodiments. As illustrated there, a display 604 is presenting a view of the “Space Adventures Game” during an ad session in which the main game presentation is overlaid with an ad window 610. Within ad window 610, multiple ad impressions might occur although only one is shown in the illustration in FIG. 6. The user might be presented with a number of options while viewing the ad presentation, such as selecting a “download” icon 612 to download the advertised (“Rockets Plus”) game, a “back” icon 614 to return to a previously displayed ad presentation, a “repeat” icon 616 to replay the current ad presentation, and a “skip” icon 618 to allow the user to move to the next ad impression in the ad collection. It may be that if an ad campaign has a specified minimum playing time, skip icon 618 might be greyed out for the duration of the minimum playing time period. The user might use icon 620 to select one of the other icons and or otherwise interact with the ad impression. Other icons might be used as well, such as a “skip all ads” icon that appears after a minimum time of the ad session has passed. The icon presentation might be in an icon display portion 622 that is generated by code provided by an API and not part of the ad campaign itself.

In another variation, the ad campaign might be presented in a full screen, such as a video that overlies all of a game display area. In such variations, the presentation might provide for user interaction with the presentation of the ad campaign, such as with swiping motions on a user interface.

In some cases, the user might be provided with “rewarded ad” capability, where the user is rewarded objects and/or advantages in the game for initiating and watching ad impressions in user-initiated ad sessions.

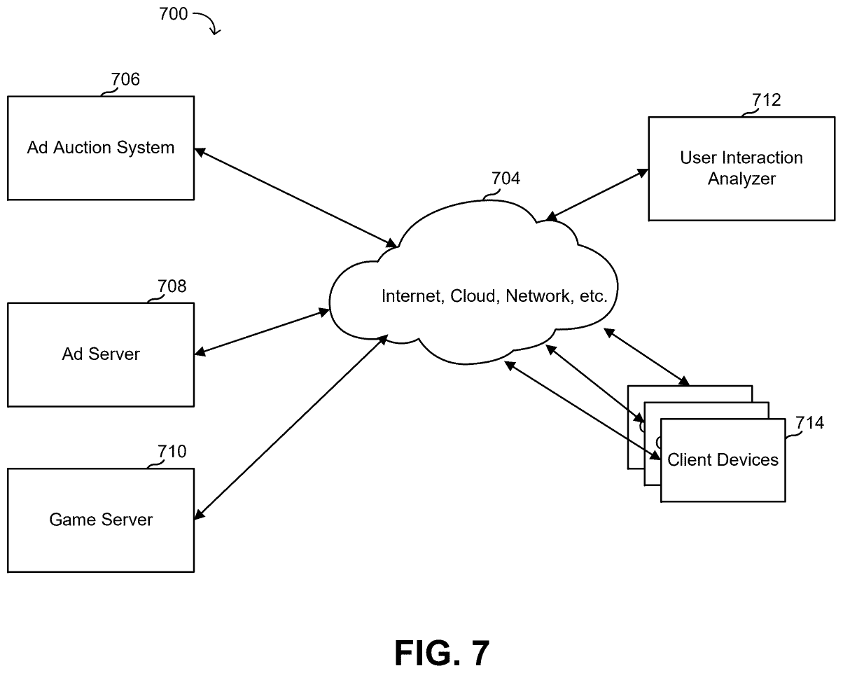

FIG. 7 is a block diagram of various components and their connections, according to various embodiments. As shown there, a system 700 comprises a distributed communication system 704 such as the Internet, a cloud infrastructure, and/or a network thereby allowing different components to be physically and/or logically remotely located relative to each other. Such components might include an ad auction system 706, an ad server 708, a game server 710, a user interaction analyzer 712, and various client devices 714. It should be understood that various communication pathways described herein might be carried over distributed communication system 704.

As explained herein, an advertisement server might receive an ad request from a game server or a client device and return a collection of ad campaigns in response to the ad request. The collection can include a plurality of ad campaigns, and a user of a client device can interact with the client device during an ad session to select among the plurality of ad campaigns of that collection to be ad impressions presented to the user. The client device handles the interaction and presentation during an ad session using and client-side ad handling module. The client-side ad handling module can record the user interactions and provide those user interactions to an interaction analysis system.

In a specific example, a user uses a client device to play a streaming video game that is being downloaded from a game server. At a predetermined time, or at a predetermined place in the game flow, or in response to a user request, an ad session begins. In the ad session, through the client device running the client-side ad handling module, the user is presented with a first advertisement of the collection. The user can choose to move from the first advertisement of the collection to a next advertisement of the collection by, for example, swiping the first advertisement. The swiping can continue through subsequent advertisements of the collection, perhaps also allowing the user to swipe backwards to see earlier advertisements in the collection.

The advertisements might include some indicator that the user can swipe the ad to see the next ad. The collection of advertisements might have a specified order, and a specified order might be reflective of auction results. For example, suppose multiple advertisers bid on N thousands of advertising presentations in game XYZ for geographic area DEF in a time period 6:00 to 6:59 PM and not all advertisers can be accommodated and there is an auction for placement slots meeting those filter parameters. Suppose there is one highest bidder for those advertisement placement slots and multiple other bidders. The collection of ad impressions might order the individual ad impressions with the highest bidder having the first advertisement or advertisements of the collection and losing bidders having later positions in the collection. In some cases, a collection of ad impressions might include some advertisements from advertisers who did not participate in an auction. Other variations of auction processes might be used to determine which ad campaigns are served and included in ad collections.

The client-side ad handling module can record user interaction with the advertising session, such as how long the user viewed a particular advertisement before swiping to the next advertisement, whether the user clicked on a link in the advertisement or took some other action, etc. The recorded interaction might be ad watch duration, a user interaction, or a user conversion in which a user converts from an advertisement viewer to a customer of the advertiser.

A collection of user interactions over large population could be used for determining the effectiveness of an ad campaign or fed into a machine learning system as training data, or other uses. This information can also be used for specific user interactions to refine an understanding of the interests of the user. For example, if a specific user is shown, during a number of ad sessions, advertisements for games involving cute animals bounding through a forest, advertisements for first-person shooter games, and advertisements for social gaming and their pattern of swiping is to spend time on cute animal games and quickly swipe passed social gaming advertisements, the number of social gaming advertisements for presentation to that user might be reduced.

The ad session duration might be a predetermined time period, such as 15 seconds, 30 seconds, 2 minutes, etc., might be a time period that goes until the user performs a particular action, such as leaving the game to visit an advertiser's website, or might run until the user has swiped through the entire collection of the ad session or a predetermined number of ads in the ad session.

One example of user interaction with an ad session collection might be a swipe action while an advertisement is playing, leading to the next advertisement or a previous advertisement. Other examples pf user interactions might be clicking an icon to register a request to move to the next advertisement or to remain on the current advertisement as it plays out.

In some embodiments, the collection of ad impressions comprises advertisements from a single advertiser for different products or variations, and in some embodiments a collection of ad impressions might comprise advertisements from unrelated advertisers. In some embodiments, it might be that only one ad impression of the collection of ad impressions is the result of winning auction. In some embodiments, a curation process might be used to select which ad impressions are in the collection and their order.

Using the ad session methods described herein, a collection of ad impressions can be presented to a user with user ability to interact with the ad impressions in the collection. Thus, a user can select which advertisements to engage with, bypassing ads they find unappealing, enhancing the potential for discovering games that align with their interests.

Using the ad session methods described herein, a game streaming environment or other content providing environment that is at least partially ad-supported, can capture insights through user interactions within an ad unit, providing signals on user preferences and engagement patterns, which might in turn be fed to a machine learning system.

In a specific interaction, a user engages with video content using their client device, such as playing a video game, and during that engagement, their client device is programmed to invoke a client-side ad handling module to effect an ad session. During an ad session, the client device runs the client-side ad handling module and a collection of ad impressions is obtained, whether all at once downloaded to the client device, or obtained or streamed as needed. The client-side ad handling module accepts user input, such as swipe inputs, to signal the user's desire to move to the next ad, move to a prior ad, or interact with the current ad. This might be used to scroll through advertised games to discover interesting games.

There can be multiple video ads in one ad session from different advertisers, or the same advertiser. An existing ad-supported content provision system can be retrofitted with this ad session program with little additional work and possibly no additional work required from advertisers or publishers. The client-side ad handling module described here can be a replacement for an existing ad presentation module.

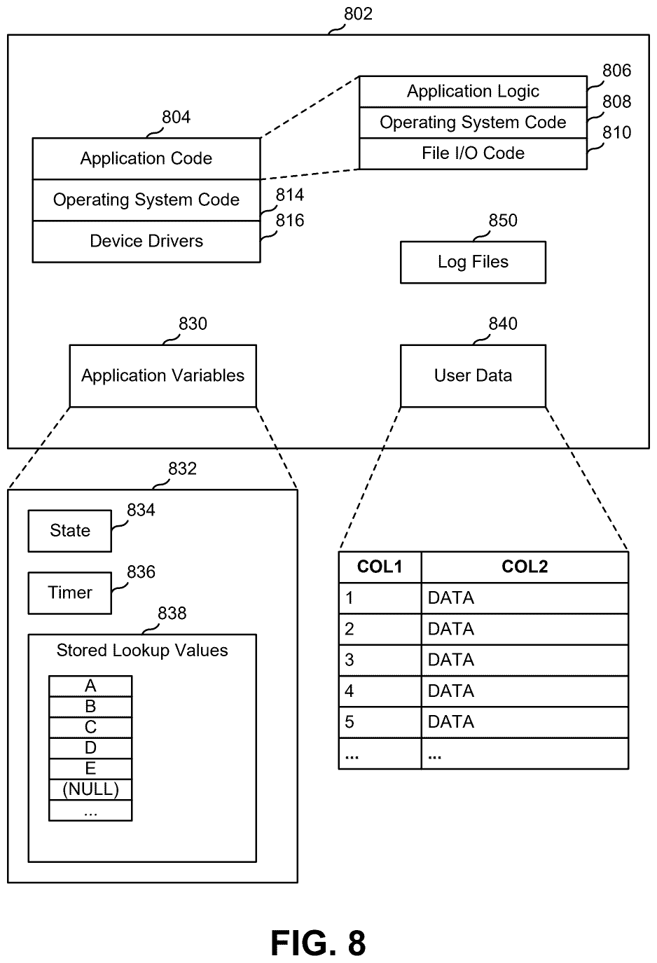

FIG. 8 is a simplified functional block diagram of a storage device 802 having an application that can be accessed and executed by a processor in a computer system as might be part of embodiments of a content providing infrastructure and/or a computer system that provides user content interspersed with advertisements. FIG. 8 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 802 can be one or more memory device that can be accessed by a processor and storage device 802 can have stored thereon application code 84 that can be one or more processor readable instructions, in the form of write-only memory and/or writable memory. Application code 84 can include application logic 86, library functions 88, and file I/O functions code 810 associated with the application. The memory elements of FIG. 8 might be used for a server or computer that interfaces with a user, generates data, and/or manages other aspects of a process described herein. In addition to application code 84, storage device 802 might also contain operating system code 814 and device drivers 816.

Storage device 802 can also include storage for application variables 830 that can include one or more storage locations configured to receive variables 832. Application variables 830 can include variables that are generated by the application or otherwise local to the application, such as state variables 834, timers 836, and/or stored lookup values 838. Application variables 830 can be generated, for example, from data retrieved from an external source, such as a user or an external device or application. A processor can execute application code 84 to generate application variables 830 provided to storage device 802. Application variables 830 might include operational details needed to perform the functions described herein.

Storage device 802 can include storage for databases and other data described herein. One or more memory locations can be configured to store user data 840, which might include data sourced by an external source, such as a user or an external device. User data 840 can include, for example, records being passed between servers prior to being transmitted or after being received. Other data might also be supplied.

Storage device 802 can also include log files 850 having one or more storage locations configured to store results of the application or inputs provided to the application. For example, log files 850 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

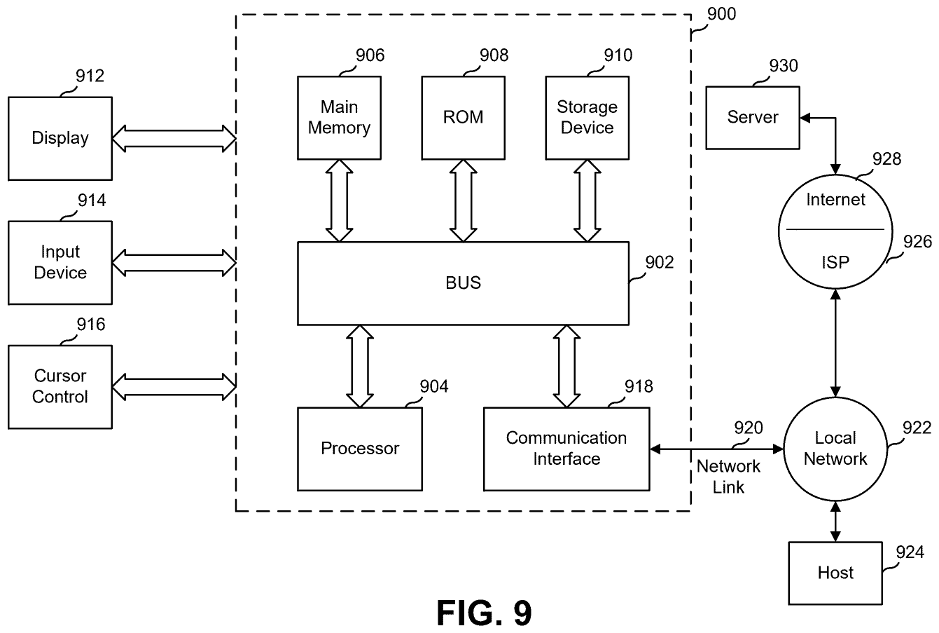

FIG. 9 is a block diagram that illustrates a computer system 900 upon which the computer systems of the systems described herein and/or data structures shown in FIG. 8 may be implemented. Computer system 900 includes a bus 902 or other communication mechanism for communicating information, and a processor 94 coupled with bus 902 for processing information. Processor 94 may be, for example, a general-purpose microprocessor.

Computer system 900 also includes a main memory 96, such as a random-access memory (RAM) or other dynamic storage device, coupled to bus 902 for storing information and instructions to be executed by processor 94. Main memory 96 may also be used for storing temporary variables or other intermediate information during execution of instructions to be executed by processor 94. Such instructions, when stored in non-transitory storage media accessible to processor 94, render computer system 900 into a special-purpose machine that is customized to perform the operations specified in the instructions.

Computer system 900 further includes a read only memory (ROM) 98 or other static storage device coupled to bus 902 for storing static information and instructions for processor 94. A storage device 910, such as a magnetic disk or optical disk, is provided and coupled to bus 902 for storing information and instructions.

Computer system 900 may be coupled via bus 902 to a display 912, such as a computer monitor, for displaying information to a computer user. An input device 914, including alphanumeric and other keys, is coupled to bus 902 for communicating information and command selections to processor 94. Another type of user input device is a cursor control 916, such as a mouse, a trackball, or cursor direction keys for communicating direction information and command selections to processor 94 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 94 executing one or more sequences of one or more instructions contained in main memory 96. Such instructions may be read into main memory 96 from another storage medium, such as storage device 910. Execution of the sequences of instructions contained in main memory 96 causes processor 94 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 910. Volatile media includes dynamic memory, such as main memory 96. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 902. Transmission media can also take the form of acoustic or light waves, such as those generated during radio-wave and infra-red data communications.

Various forms of media may be involved in carrying one or more sequences of one or more instructions to processor 94 for execution. For example, the instructions may initially be carried on a magnetic disk or solid-state drive of a remote computer. The remote computer can load the instructions into its dynamic memory and send the instructions over a network connection. A modem or network interface local to computer system 900 can receive the data. Bus 902 carries the data to main memory 96, from which processor 94 retrieves and executes the instructions. The instructions received by main memory 96 may optionally be stored on storage device 910 either before or after execution by processor 94.

Computer system 900 also includes a communication interface 918 coupled to bus 902. Communication interface 918 provides a two-way data communication coupling to a network link 920 that is connected to a local network 922. For example, communication interface 918 may be a network card, a modem, a cable modem, or a satellite modem to provide a data communication connection to a corresponding type of telephone line or communications line. Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world-wide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920, and communication interface 918. In the Internet example, a server 930 might transmit a requested code for an application program through the Internet 928, ISP 926, local network 922, and communication interface 918. The received code may be executed by processor 94 as it is received, and/or stored in storage device 910, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of presenting content to a user via a client device, wherein the content comprises a content portion and an advertisement portion, the method comprising:
requesting, from the client device, presentation content from a content server;
presenting, using the client device, a presentation derived from the presentation content;
determining when the presentation reaches an advertisement insertion point in the presentation;
prior to reaching the advertisement insertion point, requesting an ad collection, the ad collection comprising a plurality of ad impressions;
for an advertisement presentation for the advertisement insertion point, presenting the user with a first ad impression of the ad collection;
receiving user interactions of the user with the first ad impression;
recording at least indicia of the user interactions as stored actions data; and
taking an action in response to the user interactions, wherein the action for at least one specific user interaction is to change from presenting the first ad impression to presenting a second ad impression of the ad collection.

2. The method of claim 1, wherein the presentation content comprises an interactive video game and the user interactions include a swiping motion of the user on a display screen of the client device.

3. The method of claim 2, wherein the action in response to the user interaction is selected from playing a current ad presentation, skipping the current ad presentation, moving to a next ad presentation of the ad collection, or returning to a prior ad presentation of the ad collection, with a selection being determined based on a type of the swiping motion of the user.

4. The method of claim 1, wherein the plurality of ad impressions of the ad collection consists of ad impressions of one advertiser.

5. The method of claim 1, wherein the ad collection further comprises an indication of ordering among the plurality of ad impressions of the ad collection, including the first ad impression and a last ad impression.

6. The method of claim 5, wherein the plurality of ad impressions of the ad collection comprises ad impressions of more than one advertiser and the ordering among the plurality of ad impressions of the ad collection is determined by an auction process and bids placed by advertisers of the more than one advertiser.

7. The method of claim 1, wherein requesting the ad collection comprises sending an ad collection request from the client device to the content server to be forwarded to an ad server.

8. The method of claim 1, wherein requesting the ad collection comprises sending an ad collection request from the client device to an ad server that is distinct from the content server.

9. The method of claim 1, wherein the advertisement insertion point represents a point in a game suitable for a break in game play action, a first predetermined time since a game start time, a second predetermined time since a prior advertisement insertion point, a user-initiated ad break, and/or a combination thereof.

10. The method of claim 1, wherein an ad session begins at the advertisement insertion point and has an ad session period after which the presentation resumes.

11. The method of claim 10, wherein the ad session period is a fixed, predetermined period of time.

12. The method of claim 10, wherein the ad session period lasts until a session ending user action is detected.

13. The method of claim 10, wherein the ad collection further comprises an indication of ordering among the plurality of ad impressions of the ad collection, including the first ad impression and a last ad impression and the ad session period lasts until the user is presented with the last ad impression.

14. The method of claim 1, further comprising processing the stored actions data of the user with other stored actions data of other users, wherein the processing is performed by a machine learning system trained on the stored actions data of a plurality of users.

15. A client device comprising:
storage for presentation content received from a content server;
a user interface for presenting content and receiving user input from a user of the client device;
a network interface usable for communication with remote devices; and
a processor for executing program instructions stored on the client device, the program instructions including instructions to carry out the method of claim 1.

16. A computer-readable medium carrying instructions, which when executed by at least one processor of a computer system, cause the computer system to:
store presentation content received from a content server;
present, to a user interface, a presentation derived from the presentation content;
receive user input from a user of a client device;
determine when the presentation reaches an advertisement insertion point in the presentation;
request an ad collection comprising a plurality of ad impressions;
present the user with a first ad impression of the ad collection in an advertisement presentation for the advertisement insertion point;
record at least indicia of user interactions of the user interacting with the first ad impression, recorded as stored actions data; and
take an action in response to the user interactions, wherein the action for at least one specific user interaction is to change from presenting the first ad impression to presenting a second ad impression of the ad collection.

17. The computer-readable medium of claim 16, wherein the instructions, when executed by the at least one processor of the computer system, further cause the computer system to:
process the presentation content as an interactive video game and the user interactions include a swiping motion of the user on a display screen of the client device,
wherein taking the action in response to the user interactions comprises one or more of playing a current ad presentation, skipping the current ad presentation, moving to a next ad presentation of the ad collection, and/or returning to a prior ad presentation of the ad collection, with a selection being determined based on a type of the swiping motion of the user.

18. The computer-readable medium of claim 16, wherein the ad collection further comprises an indication of ordering among the plurality of ad impressions of the ad collection, including the first ad impression and a last ad impression, and wherein the plurality of ad impressions of the ad collection comprises ad impressions of more than one advertiser and the ordering among the plurality of ad impressions of the ad collection is determined by an auction process and bids placed by advertisers of the more than one advertiser.

19. The computer-readable medium of claim 16, wherein the instructions process the advertisement insertion point as a point in a game suitable for a break in game play action, a first predetermined time since a game start time, a second predetermined time since a prior advertisement insertion point, and/or a combination thereof.

20. The computer-readable medium of claim 16, wherein the instructions, when executed by the at least one processor of the computer system, further cause the computer system to initiate an ad session wherein the ad session (a) begins at the advertisement insertion point and has an ad session period after which the presentation resumes, (b) wherein the ad session period is a fixed, predetermined period of time, and/or (c) wherein the ad session period lasts until an ad session ending user action is detected.

21. The computer-readable medium of claim 20, wherein the instructions, when executed by the at least one processor of the computer system, further cause the computer system to process the ad collection as comprising an indication of ordering among the plurality of ad impressions of the ad collection, including the first ad impression and a last ad impression and executing the ad session for the ad session period that lasts until the user is presented with the last ad impression.
